(19) United States
(12) Patent Application Publication
(10) Pub. No.: US 2015/0243263 A1
(43) Pub. Date: Aug. 27, 2015

(54) Multifunction device to manipulate strings on a stringed instrument

(71) Applicants: Sheila McBride, Turlock, CA (US); Kevin Allen Kinnu, Turlock, CA (US); John Kregness, Turlock, CA (US)

(72) Inventors: Sheila McBride, Turlock, CA (US); Kevin Allen Kinnu, Turlock, CA (US); John Kregness, Turlock, CA (US)

(21) Appl. No.: 13/261,637

(22) PCT Filed: Aug. 3, 2011
(86) PCT No.: PCT/US2011/046393

§ 371 Date: Apr. 28, 2015

Related U.S. Application Data
(60) Provisional application No. 61/370,321, filed on Aug. 3, 2010.

(51) Int. Cl. G10D 3/16

(52) U.S. Cl. CPC G10D 3/163

(57) ABSTRACT

A device to manipulate the strings on a stringed musical instrument with less friction and resistance than a traditional pick, allowing for faster and more responsive string contact, more control, accentuated sound, and it is more comfortable to use than other guitar picks available. The device offers a plurality of functions, providing an alternative to musicians who want to extend playing capabilities without spending a lot or having to carry several devices.

### TECHNICAL FIELD

The present invention relates to an accessory for stringed musical instruments, more specifically an ergonomically comfortable device with multiple unique playing edges that manipulate the strings on a stringed musical instrument, and can be used for various functions to achieve a plurality of effects, reduce physical stress on a musician, and enhance the sound of the stringed instrument.

### BACKGROUND ART

This application claims an invention which was disclosed in Provisional Application No. 61/370,321, filed 3 Aug. 2010 entitled “Multifunction device to manipulate the strings on a stringed musical instrument”. The benefit under 35 USC §119(e) of the United States provisional application is hereby claimed, and the aforementioned application is hereby incorporated herein by reference.

### DISCLOSURE OF INVENTION

Musicians who play stringed instruments usually use some sort of device to manipulate the strings by plucking, scraping, brushing, sliding across or otherwise engaging the strings. Different devices cause different effects and sounds. Products available today are limited, in order to accomplish a variety of effects or sounds one would need several different devices. This is inconvenient, and can get expensive.

Current picks for stringed instruments are not designed to reduce friction or resistance and are not easy to hold on to. They must be gripped tightly to maintain control, causing fatigue and physical stress to the musician. This fatigue and physical stress puts limitations on the musician and affects performance, as well as limits the sound quality of the instrument.

### BRIEF DESCRIPTION OF DRAWINGS

FIG. 1 is a front view of a two piece embodiment of the invention fully assembled.

FIG. 2 is a view of the side of the two piece embodiment, assembled.

FIG. 3 Is a front view of the two piece embodiment, partially separated.

FIG. 4 shows the two piece embodiment with each piece detached from the other from the front.

FIG. 5 is a side view of the two pieces detached from one another.

FIG. 6 illustrates a front view of a one piece embodiment of the device, focused on the top of the device.

FIG. 7 is also a front view of a one piece design, focused on the bottom edge.

FIG. 8 shows a side view of a one piece embodiment.

### DETAILED DESCRIPTION OF THE INVENTION

The following describes in detail two embodiments of the invention. This description should not be construed as limiting the invention to these particular embodiments. Those skilled in their arts will recognize numerous other embodiments.

The invention is a device to be used with stringed musical instruments. It can be used in a variety of ways, each resulting in a different effect. In all of the drawings the number 1 corresponds to the Pick Body, or the section of the device that is gripped. The number 2 corresponds to the Plucking Edge, or the section that is used to pluck, pick, strum, or otherwise engage the strings as you would with a traditional guitar or mandolin pick.

The number 3 is a reference to a Supplemental Playing Edge, or a portion that can be used for a multitude of functions such as, but not limited to, bowing, hammering, tapping, sliding, and scraping. There may be more than one Supplemental Playing Edge on some embodiments of the invention; they may be permanently affixed or might be detachable or interchangeable. The number 4 represents a means to securely hold the components together, which could be accomplished by many other methods than those illustrated here. These components are discussed further in the next section entitled “Best Mode For Carrying Out The Invention”.

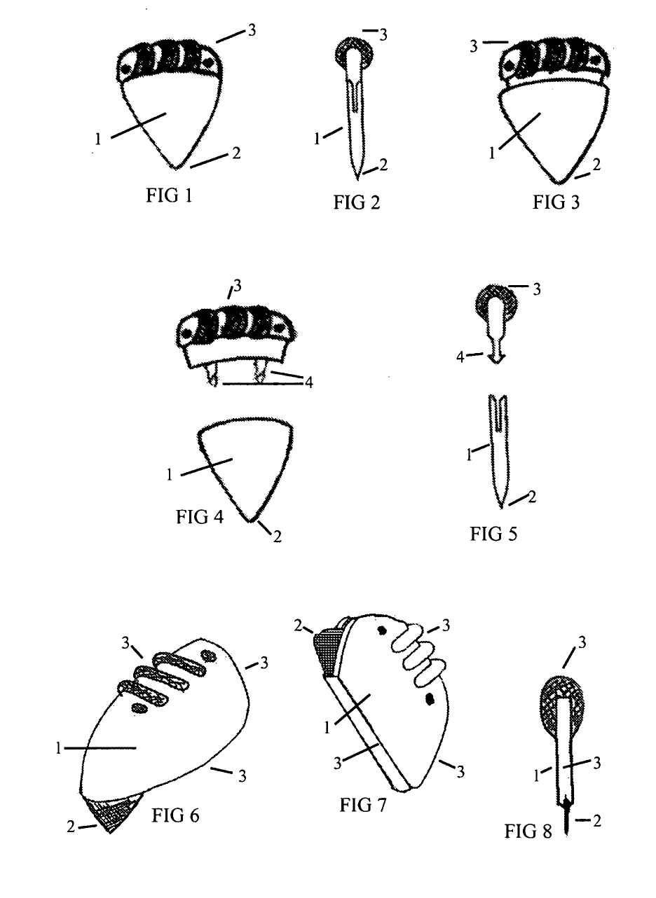

FIG. 1 is an embodiment of the invention made from two pieces, the Supplemental Playing Edge being detachable and interchangeable with other Supplemental Playing Edges. This illustration shows the device with both pieces attached to one another, as it would be when it is being used.

FIG. 2 is a side view of the two piece embodiment with the pieces fully attached.

FIG. 3 is a front view of the Supplemental Playing Edge partially detached from the Pick Body and FIG. 4 shows the same front view with the pieces completely detached from one another. FIG. 5 is a side view of the components detached from one another.

FIG. 6 illustrates a frontal view of a one piece embodiment, from the top, and FIG. 7 shows a view of the same embodiment from the bottom. FIG. 8 is a side view of a one piece embodiment of the invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

### BEST MODE FOR CARRYING OUT THE INVENTION

The device is comprised of the following:
1 Pick body
2 Plucking edge
3 Supplemental playing edge
4 Connector/fastener

The body of the pick can be of varying sizes, shapes and materials. It is the area used to grip the device, and is a necessary component. The plucking edge is the portion that can be used to strum, pick or pluck the strings as a traditional guitar pick does. It is a necessary component.

The supplemental playing edge is the section that makes contact with and manipulates the strings on a stringed instrument in a manner different than that of a traditional guitar pick and makes our invention unique. It can be of any size or shape and made of any material or texture, depending upon the desired output. There may be one or more of these edges.

The connector or fastener is a means to hold more than one component securely together, and can be achieved by several different methods. It is not necessary for the one piece embodiment, but is crucial if there is more than one piece. Without it the device would fall apart.

In order to work, the device needs a surface to grip as well as at least one playing edge to strike or contact the strings. It also needs an edge that is of a different size, shape, or texture than the pick body to make it more comfortable to hold and easier to control, thus reducing physical stress for the musician; these elements are all necessary.

The shape and size of the gripping surface, as well as the material used to make it could vary. The supplemental playing edge can also vary greatly, depending upon what the musician wants to accomplish, and could be made with different types of surfaces and textures to produce different sounds.

The supplemental playing edge could connect to the pick body by way of a channel or groove that is inset around the outer edge, or as an extension or attachment to the pick body, and could have a single, double, or multiple edges or rows. The playing edge(s) would be positioned into the channel or groove, attachment, or extension, and held in place with the use of an adhesive material, solder, rivets, hook, screw, as an attachment or wrap, or by any other suitable means, or it could all be cast as one piece. It could be connected permanently, or be detachable and interchangeable, allowing for a greater variety of playing edges. It could be made from the same material as the pick body, or it could be made from a different material.

The device could be fabricated; formed from any suitable material by any suitable means and may be made from one or more components, The pick body could connect to the picking and supplemental playing edges by means of a bevel, groove, ridge or other reliable divider or fastener, and have any number of edges, depending upon the desired output.

### INDUSTRIAL APPLICABILITY

The invention can work in several different fashions, including but not limited to:
1. Bow across strings like a violin, angle can be varied to produce different sounds.
2. Can be used as a traditional pick by strumming or brushing the pick across the strings.
3. Can be used for tapping the strings on the fret board, producing percussive effects and expanded note passages.
4. Can be used for hammering to produce effects similar to those of a piano by hitting the strings.
5. Can be used like a traditional guitar slide by sliding it up and down the neck of the guitar, basically impersonating a steel guitar.
6. the tip of the pick body can be used to lift the strings, as finger picking does.

What is claimed is:

1. A device to manipulate the strings on a stringed musical instrument comprising:
a. an ergonomic shape that allows a musician to grip said device in a manner that causes less physical strain and fatigue than previous devices, extending said musicians capabilities and
b. an edge that is straight and smooth, said edge being of a material suitable for strumming, plucking, and brushing against the strings on a stringed musical instrument and
c. a member extruding from said body, said member being textured and having one or more rows and being of a material suitable for brushing, tapping, or scraping the strings on a stringed musical instrument.
